(19) United States
(12) Patent Application Publication
(10) Pub. No.: US 2024/0202453 A1
(43) Pub. Date: Jun. 20, 2024

(54) GENERALIZABLE INSTRUCTION FOLLOWING WITH PRE-TRAINED LANGUAGE AND GROUNDING MODELS

(71) Applicant: Honda Motor Co., Ltd., Tokyo (JP)

(72) Inventors: Gaoussou Youssouf KEBE, Pittsburgh, PA (US); Kwonjoon LEE, San Jose, CA (US); Teruhisa MISU, San Jose, CA (US)

(21) Appl. No.: 18/181,103

(22) Filed: Mar. 9, 2023

Related U.S. Application Data
(60) Provisional application No. 63/433,350, filed on Dec. 16, 2022.

(51) Int. Cl. G06F 40/30; G06F 40/205

(52) U.S. Cl. CPC G06F 40/30; G06F 40/205

(57) ABSTRACT

Systems and methods for generalizable instruction following are provided. In one embodiment, a method includes generating a plurality of abstract tuples based on a set of instructions. The method includes classifying each abstract tuple of the plurality of abstract tuples as a navigation abstract tuple, an executable interaction abstract tuple, or a complex interaction abstract tuple based on the action. The method includes discarding the abstract tuples classified as navigation abstract tuples. The method includes forming set of executable interactions including the executable interaction abstract tuple. The method includes detecting an object location for the at least one object. The method includes decoding the complex interaction abstract tuples into executable interaction abstract tuples. The method includes adding the decoded executable interaction abstract tuples to the set of executable interactions. The method includes generating an executable plan for an agent based on the set of executable interactions and the object location.

### BACKGROUND

Humans may interpret natural language commands for tasks at both abstract and fine-grained levels of specificity. For example, a human may be instructed to hang a painting “a little bit lower.” The phrase “a little bit lower” is an abstract directive because it requires the human to infer information. Continuing the example, the human may interpret the phrase “a little bit lower” and move the painting accordingly despite “a little bit lower” being an abstract directive. However, abstract directives may not be translatable by robots. Thus, robots may encounter inefficient planning and increased execution times as they attempt to perform tasks that include levels of abstraction.

### BRIEF DESCRIPTION

According to one aspect, a system is provided that includes a processor and a memory storing instructions. When executed by the processor, the instructions cause the processor to generate a plurality of abstract tuples based on a set of instructions. An abstract tuple of the plurality of abstract tuples includes at least one action and at least one object. The instructions also cause the processor to classify each abstract tuple of the plurality of abstract tuples as a navigation abstract tuple, an executable interaction abstract tuple, or a complex interaction abstract tuple based on the at least one action. The executable interaction abstract tuple includes a single executable interaction and the complex interaction abstract tuple includes multiple executable interactions. The instructions further cause the processor to discard the abstract tuples classified as navigation abstract tuples. The instructions yet further cause the processor to form a set of executable interactions including the executable interaction abstract tuple. The instructions cause the processor to detect an object location for the at least one object based on a knowledge base. The instructions also cause the processor to decode the complex interaction abstract tuples into executable interaction abstract tuples. The instructions further cause the processor to add the decoded executable interaction abstract tuples to the set of executable interactions. The instructions yet further cause the processor to generate an executable plan for an agent based on the set of executable interactions and the object location.

According to another aspect, a computer-implemented method for generalizable instruction following with pre-trained language and grounding models is provided. The computer-implemented method includes generating a plurality of abstract tuples based on a set of instructions. An abstract tuple of the plurality of abstract tuples includes at least one action and at least one object. The computer-implemented method also includes classifying each abstract tuple of the plurality of abstract tuples as a navigation abstract tuple, an executable interaction abstract tuple, or a complex interaction abstract tuple based on the at least one action. The executable interaction abstract tuple includes a single executable interaction and the complex interaction abstract tuple includes multiple executable interactions. The computer-implemented method further includes discarding the abstract tuples classified as navigation abstract tuples. The computer-implemented method yet further includes forming set of executable interactions including the executable interaction abstract tuple. The computer-implemented method includes detecting an object location for the at least one object based on a knowledge base. The computer-implemented method also includes decoding the complex interaction abstract tuples into executable interaction abstract tuples. The computer-implemented method further includes adding the decoded executable interaction abstract tuples to the set of executable interactions. The computer-implemented method yet further includes generating an executable plan for an agent based on the set of executable interactions and the object location.

According to yet another aspect, a non-transitory computer readable storage medium storing instructions that when executed by a computer, which includes a processor, perform a method for generalizable instruction. The method includes generating a plurality of abstract tuples based on a set of set of instructions. An abstract tuple of the plurality of abstract tuples includes at least one action and at least one object. The method also includes classifying each abstract tuple of the plurality of abstract tuples as a navigation abstract tuple or an interaction abstract tuple based on the at least one action. The method further includes discarding the abstract tuples classified as navigation abstract tuples. The method yet further includes detecting an object location for the at least one object based on a knowledge base. The method includes classifying each interaction abstract tuple as an executable interaction abstract tuple or a complex interaction abstract tuple. The executable interaction abstract tuple includes a single executable interaction and the complex interaction abstract tuple includes multiple executable interactions. The method also includes forming a set of executable interactions including the executable interaction abstract tuple. The method further includes decoding the complex interaction abstract tuples into executable interaction abstract tuples. The method yet further includes adding the decoded executable interaction abstract tuples to the set of executable interactions. The method includes generating an executable plan for an agent based on the set of executable interactions and the object location.

### BRIEF DESCRIPTION OF THE DRAWINGS

FIG. 1 is an exemplary component diagram of a system for generalizable instruction, according to one aspect.

FIG. 2 is an exemplary agent environment of a system for generalizable instruction, according to one aspect.

FIG. 3 is an exemplary process flow of a method for generalizable instruction following, according to one aspect.

FIG. 4 is a schematic diagram for generalizable instruction following, according to one aspect.

FIG. 5 is another exemplary process flow of a method for generalizable instruction following, according to one aspect.

FIG. 6 is an illustration of an example computer-readable medium or computer-readable device including processor-executable instructions configured to embody one or more of the provisions set forth herein, according to one aspect.

### DETAILED DESCRIPTION

In order to follow human instructions, robots need to be able to identify a diverse range of objects and perform an array of tasks. Following human instructions is further complicated by the dynamic nature of human environments. For example, new object categories and tasks may be introduced in the human environment. Furthermore, human instructions are underspecified and ambiguous. Therefore, while humans are able to “fill in the gap” using commonsense, agents have been historically unable to execute unspecified instructions. For these reasons, current deep-learning based approaches tend to perform poorly for unseen tasks and object classes.

Here, systems and methods for generalizable instruction following with pre-trained language and grounding models are provided. In particular, a semantic parser generates abstract tuples for actions and their arguments (e.g., an object, command, etc.) to form a set of instructions. The abstract tuples are then classified into instruction categories. The instruction categories may include a navigation abstract tuple, an executable interaction abstract tuple, or a complex interaction abstract tuple. The abstract tuples are classified into instruction categories based on the presence of at least one action, such as a path verb, or a number of executable interactions. The navigation tuples may then be discarded as the systems and methods may not rely on instructions to find objects. Instead, semantic maps and common-sense candidates from large language models may used. For example, a bidirectional encoder representation form transformers (BERT) may be used to propose semantically meaningful candidates for masked tokens.

Any abstract tuples classified as complex interaction abstract tuples are decoded into a set of executable interaction abstract tuples. For example, a semantic map may be generated based on a depth prediction model and grounded language-image pre-training. The semantic map may be used to convert bounding boxes from sensor data to natural language phrases. Thus, complex object interactions are translated into simple executable interactions as executable interaction abstract tuples. An executable plan for an agent may then be generated based on the executable interaction abstract tuples.

### Definitions

The following includes definitions of selected terms employed herein. The definitions include various examples and/or forms of components that fall within the scope of a term and that may be used for implementation. The examples are not intended to be limiting. Furthermore, the components discussed herein, may be combined, omitted, or organized with other components or into different architectures.

“Agent” as used herein is a self-propelled machine that moves through or manipulates an environment. Exemplary agents may include, but is not limited to, robots, vehicles, or other self-propelled machines. The agent may be autonomously, semi-autonomously, or manually operated.

“Agent system,” as used herein may include, but is not limited to, any automatic or manual systems that may be used to enhance the agent, propulsion, and/or operation. Exemplary systems include, but are not limited to: an electronic stability control system, an anti-lock brake system, a brake assist system, an automatic brake prefill system, a low speed follow system, a cruise control system, an auto cruise control system, a lane departure warning system, a blind spot indicator system, a lane keep assist system, a navigation system, a steering system, a transmission system, brake pedal systems, an electronic power steering system, visual devices (e.g., camera systems, proximity sensor systems), an electronic pretensioning system, a monitoring system, a passenger detection system, a suspension system, a seat configuration system, a cabin lighting system, an audio system, a sensory system, an interior or exterior camera system among others.

“Bus,” as used herein, refers to an interconnected architecture that is operably connected to other computer components inside a computer or between computers. The bus may transfer data between the computer components. The bus may be a memory bus, a memory processor, a peripheral bus, an external bus, a crossbar switch, and/or a local bus, among others. The bus may also be a bus that interconnects components inside an agent using protocols such as Media Oriented Systems Transport (MOST), Controller Area network (CAN), Local Interconnect network (LIN), among others.

“Component,” as used herein, refers to a computer-related entity (e.g., hardware, firmware, instructions in execution, combinations thereof). Computer components may include, for example, a process running on a processor, a processor, an object, an executable, a thread of execution, and a computer. A computer component(s) may reside within a process and/or thread. A computer component may be localized on one computer and/or may be distributed between multiple computers.

“Computer communication,” as used herein, refers to a communication between two or more communicating devices (e.g., computer, personal digital assistant, cellular telephone, network device, vehicle, computing device, infrastructure device, roadside equipment) and may be, for example, a network transfer, a data transfer, a file transfer, an applet transfer, an email, a hypertext transfer protocol (HTTP) transfer, and so on. A computer communication may occur across any type of wired or wireless system and/or network having any type of configuration, for example, a local area network (LAN), a personal area network (PAN), a wireless personal area network (WPAN), a wireless network (WAN), a wide area network (WAN), a metropolitan area network (MAN), a virtual private network (VPN), a cellular network, a token ring network, a point-to-point network, an ad hoc network, a mobile ad hoc network, a vehicular ad hoc network (VANET), a vehicle-to-vehicle (V2V) network, a vehicle-to-everything (V2X) network, a vehicle-to-infrastructure (V2I) network, among others. Computer communication may utilize any type of wired, wireless, or network communication protocol including, but not limited to, Ethernet (e.g., IEEE 802.3), WiFi (e.g., IEEE 802.11), communications access for land mobiles (CALM), WiMax, Bluetooth, Zigbee, ultra-wideband (UWAB), multiple-input and multiple-output (MIMO), telecommunications and/or cellular network communication (e.g., SMS, MMS, 3G, 4G, LTE, 5G, GSM, CDMA, WAVE), satellite, dedicated short range communication (DSRC), among others.

“Communication interface” as used herein may include input and/or output devices for receiving input and/or devices for outputting data. The input and/or output may be for controlling different agent features, which include various agent components, systems, and subsystems. Specifically, the term “input device” includes, but is not limited to: keyboard, microphones, pointing and selection devices, cameras, imaging devices, video cards, displays, push buttons, rotary knobs, and the like. The term “input device” additionally includes graphical input controls that take place within a user interface which may be displayed by various types of mechanisms such as software and hardware-based controls, interfaces, touch screens, touch pads or plug and play devices. An “output device” includes, but is not limited to, display devices, and other devices for outputting information and functions.

“Computer-readable medium,” as used herein, refers to a non-transitory medium that stores instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device may read.

“Database,” as used herein, is used to refer to a table. In other examples, “database” may be used to refer to a set of tables. In still other examples, “database” may refer to a set of data stores and methods for accessing and/or manipulating those data stores. In one embodiment, a database may be stored, for example, at a disk, data store, and/or a memory. A database may be stored locally or remotely and accessed via a network.

“Data store,” as used herein may be, for example, a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD ROM). The disk may store an operating system that controls or allocates resources of a computing device.

“Display,” as used herein may include, but is not limited to, LED display panels, LCD display panels, CRT display, touch screen displays, among others, that often display information. The display may receive input (e.g., touch input, keyboard input, input from various other input devices, etc.) from a user. The display may be accessible through various devices, for example, though a remote system. The display may also be physically located on a portable device, mobility device, or host.

“Logic circuitry,” as used herein, includes, but is not limited to, hardware, firmware, a non-transitory computer readable medium that stores instructions, instructions in execution on a machine, and/or to cause (e.g., execute) an action(s) from another logic circuitry, module, method and/or system. Logic circuitry may include and/or be a part of a processor controlled by an algorithm, a discrete logic (e.g., ASIC), an analog circuit, a digital circuit, a programmed logic device, a memory device containing instructions, and so on. Logic may include one or more gates, combinations of gates, or other circuit components. Where multiple logics are described, it may be possible to incorporate the multiple logics into one physical logic. Similarly, where a single logic is described, it may be possible to distribute that single logic between multiple physical logics.

“Memory,” as used herein may include volatile memory and/or nonvolatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

“Module,” as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another module, method, and/or system. A module may also include logic, a software-controlled microprocessor, a discrete logic circuit, an analog circuit, a digital circuit, a programmed logic device, a memory device containing executing instructions, logic gates, a combination of gates, and/or other circuit components. Multiple modules may be combined into one module and single modules may be distributed among multiple modules.

“Operable connection,” or a connection by which entities are “operably connected,” is one in which signals, physical communications, and/or logical communications may be sent and/or received. An operable connection may include a wireless interface, firmware interface, a physical interface, a data interface, and/or an electrical interface.

“Portable device,” as used herein, is a computing device typically having a display screen with user input (e.g., touch, keyboard) and a processor for computing. Portable devices include, but are not limited to, handheld devices, mobile devices, smart phones, laptops, tablets, e-readers, smart speakers. In some embodiments, a “portable device” could refer to a remote device that includes a processor for computing and/or a communication interface for receiving and transmitting data remotely.

“Processor,” as used herein, processes signals and performs general computing and arithmetic functions. Signals processed by the processor may include digital signals, data signals, computer instructions, processor instructions, messages, a bit, a bit stream, that may be received, transmitted and/or detected. Generally, the processor may be a variety of various processors including multiple single and multicore processors and co-processors and other multiple single and multicore processor and co-processor architectures. The processor may include logic circuitry to execute actions and/or algorithms.

### I. System Overview

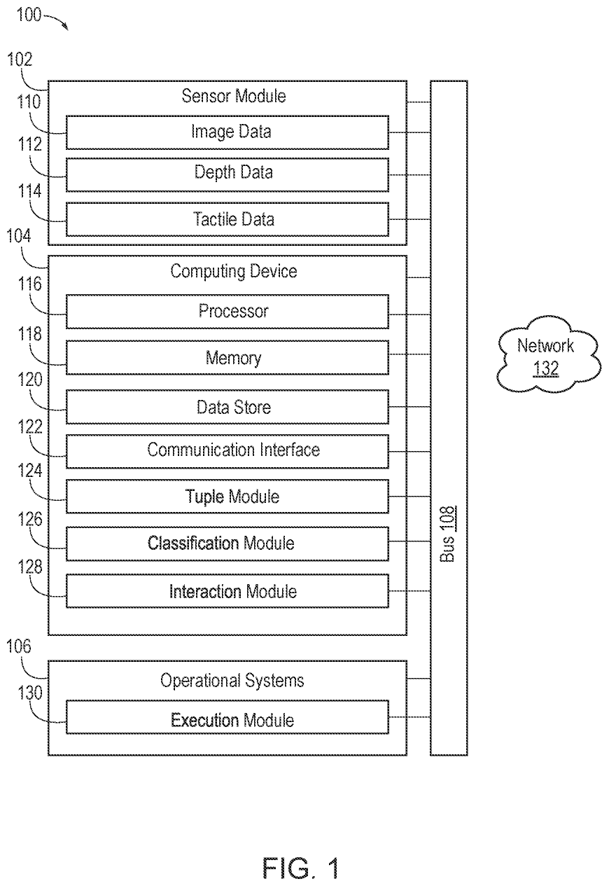

Referring now to the drawings, the drawings are for purposes of illustrating one or more exemplary embodiments and not for purposes of limiting the same. FIG. 1 is an exemplary component diagram of an operating environment 100 for generalizable instruction following, according to one aspect. The operating environment 100 includes a sensor module 102, a computing device 104, and operational systems 106 interconnected by a bus 108. The components of the operating environment 100, as well as the components of other systems, hardware architectures, and software architectures discussed herein, may be combined, omitted, or organized into different architectures for various embodiments. The computing device 104 may be implemented with a device or remotely stored.

The computing device 104 may be implemented as a part of an agent. The agent may be bipedal, two-wheeled, four-wheeled robot, vehicle, or self-propelled machine. The autonomous ego agent may be configured as a humanoid robot. The humanoid robot may take the form of all or a portion of a robot. For example, the humanoid robot may take the form of an arm with fingers. The computing device 104 may be implemented as part of a telematics unit, a head unit, a navigation unit, an infotainment unit, an electronic control unit, among others of an agent. In other embodiments, the components and functions of the computing device 104 may be implemented, for example, with other devices (e.g., a portable device) or another device connected via a network (e.g., a network 132). The computing device 104 may be capable of providing wired or wireless computer communications utilizing various protocols to send/receive electronic signals internally to/from components of the operating environment 100. Additionally, the computing device 104 may be operably connected for internal computer communication via the bus 108 (e.g., a Controller Area Network (CAN) or a Local Interconnect Network protocol bus) to facilitate data input and output between the computing device 104 and the components of the operating environment 100.

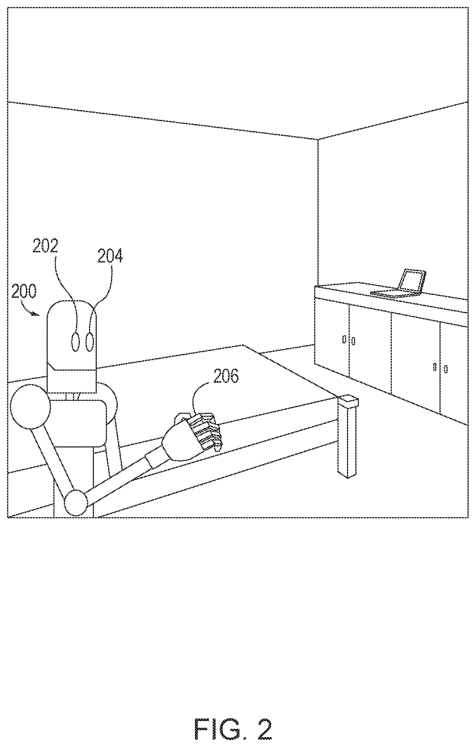

In some embodiments, the ego agent may be the agent 200 shown in FIG. 2. The agent 200 may include a number of sensors. For example, the agent 200 may include a first optical sensor 202, a second optical sensor 204, and a force sensor 206. The first optical sensor 202, the second optical sensor 204, and the force sensor 206 receive data from an environment of an object. The sensor module 102 receives, provides, and/or senses information associated with the agent 200, an object, the operating environment 100, an environment of the agent 200, and/or the operational systems 106. In one embodiment, the sensor module 102 may receive image data 110, depth data 112, and tactile data 114 from the sensors. For example, the sensor module 102 may receive image data 110 from the first optical sensor 202, depth data 112 from the second optical sensor 204, and the tactile data 114 from the force sensor 206. The computing device 104 receives the image data 110, the depth data 112, and the tactile data 114 from the sensor module 102. Therefore, the image data 110, depth data 112, and tactile data 114 is raw sensor data received from their respective sensors.

Likewise, the image data 110, depth data 112, and tactile data 114 may include information about the sensors 202-206. For example, suppose the force sensor 206 is able to move. The image data 110, depth data 112, and tactile data 114 may include information about the force sensor 206 such as the relative position of the force sensor 206 to a reference point as measured by a sensor. The reference point may be the first optical sensor 202 or the second optical sensor 204. For example, the depth data 112 may include distance measurements from the second optical sensor 204 to the force sensor 206. Likewise, the tactile data 114 may include dimensions (e.g., width, height, length, etc.) of the force sensor 206.

The sensors 202-206 and/or the sensor module 102 are operable to sense a measurement of data associated with the agent 200, the operating environment 100, the object, the environment, and/or the operational systems 106 and generate a data signal indicating said measurement of data. These data signals may be converted into other data formats (e.g., numerical) and/or used by the sensor module 102, the computing device 104, and/or the operational systems 106 to generate other data metrics and parameters. It is understood that the sensors may be any type of sensor, for example, acoustic, electric, environmental, optical, imaging, light, pressure, force, thermal, temperature, proximity, gyroscope, and accelerometers, among others.

The computing device 104 includes a processor 116, a memory 118, a data store 120, and a communication interface 122, which are each operably connected for computer communication via a bus 108 and/or other wired and wireless technologies. The communication interface 122 provides software and hardware to facilitate data input and output between the components of the computing device 104 and other components, networks, and data sources, which will be described herein. Additionally, the computing device 104 also includes a tuple module 124, a classification module 126, and an interaction module 128, for generalizable instruction following facilitated by the components of the operating environment 100. The tuple module 124, the classification module 126, and the interaction module 128 may be an artificial neural network that act as a framework for machine learning, including deep learning. For example, the tuple module 124, the classification module 126, and the interaction module 128 may be a convolution neural network. In another embodiment, tuple module 124, the classification module 126, and the interaction module 128 may further include or implement concatenator, encoder, decoder, a deep neural network (DNN), a recurrent neural network, a 3D Convolutional Neural Network and/or Convolutional Long-Short Term Memory.

The computing device 104 is also operably connected for computer communication (e.g., via the bus 108 and/or the communication interface 122) to one or more operational systems 106. The operational systems 106 may include, but are not limited to, any automatic or manual systems that may be used to enhance the agent 200, operation, and/or propulsion. The operational systems 106 may dependent on the implementation. For example, the operational system may include an execution module 130. The execution module 130 monitors, analyses, operates the agent 200 to some degree. As another example, the operational systems 106 may include manipulating an object to affect a target. The operational systems 106 also include and/or are operably connected for computer communication to the sensor module 102. For example, one or more sensors of the sensor module 102 may be incorporated with the execution module 130 to monitor characteristics of the environment or the agent 200 or cause the agent to execute a path plan to traverse or manipulate the environment.

The sensor module 102, the computing device 104, and/or the operational systems 106 are also operatively connected for computer communication to the network 132. The network 132 is, for example, a data network, the Internet, a wide area network (WAN) or a local area (LAN) network. The network 132 serves as a communication medium to various remote devices (e.g., databases, web servers, remote servers, application servers, intermediary servers, client machines, other portable devices). Detailed embodiments describing exemplary methods using the system and network configuration discussed above will now be discussed in detail.

### II. Methods

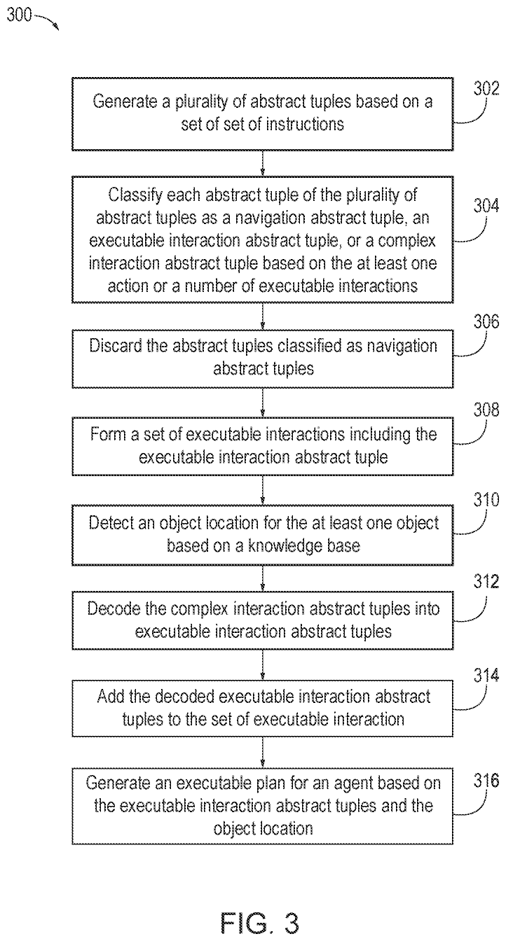

Referring now to FIG. 3, a method 300 for generalizable instruction following will now be described according to an exemplary embodiment. FIG. 3 will also be described with reference to FIGS. 1, 2, 4, and 6. For simplicity, the method 300 will be described as a sequence of elements, but it is understood that the elements of the method 300 may be organized into different architectures, blocks, stages, and/or processes.

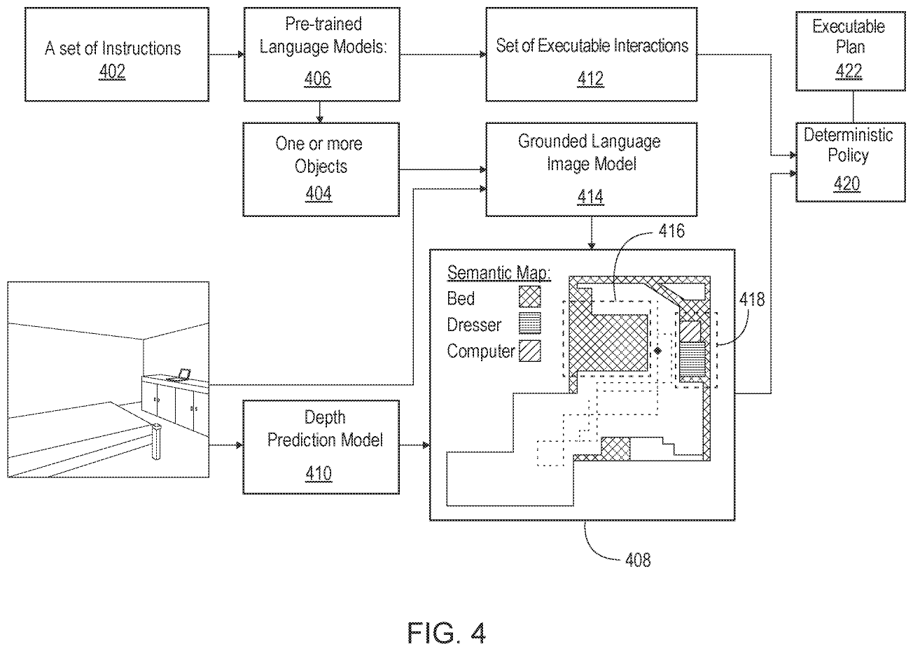

At block 302, the method 300 includes the tuple module 124 generating a plurality of abstract tuples based on a set of set of instructions 402, shown in FIG. 4. An abstract tuple of the plurality of abstract tuples includes at least one action and at least one object. In some embodiments, the tuple module 124 may be, in whole or in part, a semantic parser. For example, the tuple module 124 may use a semantic parser to generate abstract tuples for action verbs and the arguments of the action verbs of the set of instruction 402. The arguments are objects 404, including direct object and indirect objects of the set of instructions 402.

The set of instructions 402 may be received by the agent 200 from a biological entity, such as a human user. In another embodiment, the task from the biological entity may be parsed into the set of instructions 402 based on the task. For example, the agent 200 may receive a task, “put the computer on the bed,” from the biological entity. The set of instructions 402 may identify transitional activities. For example, the transitional activities of the set of instructions 402 may include “go to the dresser across from the bed,” “take the computer from the dresser,” “go to the left side of the bed,” and “place the computer on the bed next a cell phone.”

The tuple module 124 identifies action verbs and the objects 404 from the set of instructions 402 using a pretrained language model 406. The tuple module 124 may parse the action verbs and the objects 404 into abstract tuples including at least one action verb and at least one object of the objects 404. For example, the abstract tuples may include “go to; bedroom,” “go to; dresser,” “go to; bed,” “take; computer; dresser,” and “place; computer; bed,” among others. Thus, the tuple module 124 generates abstract tuples as a simplified form of the set of instructions 402. There may be more abstract tuples than instructions of the set of instructions 402.

Additionally, the pretrained language model 406 may define the objects 404 based on the set of instructions 402. For example, the set of instructions 402 may include “take the computer to the bed.” If the computer is currently positioned on a dresser, the pretrained language model 406 may identify the dresser in addition to the bed as the objects 404 based on information from the sensor module 102. For example, the image data 110 may show the computer on the dresser. Accordingly, the tuple module 124 may include additional objects in the objects 404 based on the pretrained language model 406 given the set of instructions 402 as well as the image data 110, the depth data 112, and/or the tactile data 114.

At block 304, the method 300 includes the classification module 126 classifying each abstract tuple of the plurality of abstract tuples as a navigation abstract tuple, an executable interaction abstract tuple, or a complex interaction abstract tuple based on the at least one action or a number of executable interactions. For example, if the least one action is a path verb that facilitates an agent traversing a space, such as a bedroom, the abstract tuple may be classified as a navigation abstract tuple. Path verbs may include “go to,” “turn left,” “turn right,” “move up,” “move down,” “travel south,” and “go four meters,” among others. An executable interaction abstract tuple includes a single executable interaction and the complex interaction abstract tuple includes multiple executable interactions.

Returning to the example from above, the abstract tuples may include “go to; bedroom,” “go to; dresser,” “go to; bed,” “take; computer; dresser,” and “place; computer; bed,” among others. The classification module 126 may classify “go to; dresser” and “go to; bed” as navigation abstract tuples. The classification module 126 may also classify “take; computer; dresser” and “place; computer; bed” as executable interaction abstract tuples. Further, the classification module 126 may identify “go to; bedroom,” as a complex interaction abstract tuple as it may include multiple executable interactions. For example, the complex interaction abstract tuple, “go to; bedroom,” may include moving through a hallway, turning on a light switch, turning a door handle, pushing open a door, and waling through a doorway. Because the abstract tuple is able to be dissected into a plurality of simple executable interactions, the classification module 126 classifies the abstract tuple as a complex interaction abstract tuple.

At block 306, the method 300 includes the interaction module 128 discarding the abstract tuples classified as navigation abstract tuples. Continuing the example from above, the navigation abstract tuples “go to; dresser” and “go to; bed” are discarded by the interaction module 128. The interaction module 128 may not rely on instructions to find an object of the objects 404.

In one embodiment, the interaction module 128 may determine if one or more abstract tuples classified as navigation abstract tuples have been generated by the tuple module 124. In response to determining that one more abstract tuples have been classified as a navigation abstract tuple, the interaction module 128 may discard the navigation abstract tuple. If the interaction module 128 determines that none of the abstract tuples have been classified as navigation abstract tuples, the interaction module 128 may proceed to block 308.

At block 308, the method 300 includes the interaction module 128 forming a set of executable interactions 412 including the executable interaction abstract tuple. Accordingly, based on the example, the interaction module 128 may add executable interaction abstract tuples “take; computer; dresser” and “place; computer; bed” to the set of executable interactions 412. In some embodiments, the interaction module 128 may order the executable interaction abstract tuples in a sequential order in the set of executable interactions 412. The sequential order may be based on a deterministic policy 420.

At block 310, the method 300 includes the interaction module 128 detecting an object location for an object of the one or more objects 404 based on a knowledge base. In one embodiment, the interaction module 128 may use semantic maps and common-sense candidates from large language models. In one embodiment, the tuple module 124 may detect the object location for the objects 404 by generating candidate locations based on proposing semantically meaningful candidates for masked tokens. The masked tokens represent the objects 404 in a semantic map 408 based on a depth prediction model 410 generated from as the image data 110, the depth data 112, and/or the tactile data 114.

The semantic map 408 may be based on the depth prediction model 410 as well as a grounded language-image model 414. The semantic map 408 includes a number of bounding boxes, such as a first bounding box 416 identifying a bed and a second bounding box 418 identifying a dresser in the environment of the agent 200. The grounded language-image model 414 converts bounding boxes, including the first bounding box 416 and the second bounding box 418, to natural language phrases. Thus, the first bounding box 416 and the second bounding box 418 may be used to identify the objects 404 (e.g., the bed, the dresser, etc.) and detect the object locations for the objects 404. Because the locations of the objects 404 and the features of the environment of the agent 200 may be determined using the semantic map 408, the navigation tuples are not utilized by the interaction module 128 and may be discarded at block 306.

At block 312, the method 300 includes the interaction module 128 decoding the complex interaction abstract tuples into executable interaction abstract tuples to translate complex object interacted into simple executable interactions as executable interaction abstract tuples that may be executed by an agent 200.

A large language model (e.g., a knowledge base, BERT, OPT-175, etc.) may be used by the interaction module 128 to translate the complex interaction abstract tuple into a plurality of executable interaction abstract tuples. Returning to the example from above, the complex interaction abstract tuple, “go to; bedroom,” may include moving through a hallway, turning on a light switch, turning a door handle, pushing open a door, and walking through a doorway. Accordingly, “go to; bedroom,” may be decoded into a plurality of executable interaction abstract tuples including “press; light switch,” “rotate; door handle,” “push; door,” and “traverse; doorway.” The interaction module 128 may not translate the complex interaction abstract tuple into navigation abstract tuples.

In one embodiment, the classification module 126 may classify the one or more abstract tuples decoded from the complex interaction abstract tuple. The interaction module 128 may then determine if one more abstract tuples have been classified as a navigation abstract tuple. In response to determining that one more of the decoded abstract tuples have been classified as a navigation abstract tuple, the interaction module 128 may discard the decoded navigation abstract tuple. If the interaction module 128 determines that none of the abstract tuples have been classified as navigation abstract tuples, the interaction module 128 may proceed to block 314.

At block 314, the method 300 includes the interaction module 128 adding the decoded executable interaction abstract tuples to the set of executable interactions 412. If the set of executable interactions includes the executable interaction abstract tuples “take; computer; dresser” and “place; computer; bed” from the block 308, the executable interaction abstract tuples including “press; light switch,” “rotate; door handle,” “push; door,” and “traverse; doorway,” decoded at block 312, are added to set of executable interactions 412. The decoded executable interaction abstract tuples may be added to the set of executable interactions 412 so that the decoded executable interaction abstract tuples are also in the sequential order of execution.

At block 316, the method 300 includes the interaction module 128 generating an executable plan 422 for the agent 200 based on the set of executable interactions 412 and the object location of the objects 404. The executable plan 422 may be determined based on the set of executable interactions 412 as applied to a deterministic policy 420 and the semantic map 408. The executable plan 422 may include one or more path plans or navigation corresponding to the executable interaction abstract tuples. Accordingly, the execution module 130 may cause the agent 200 to execute the executable plan.

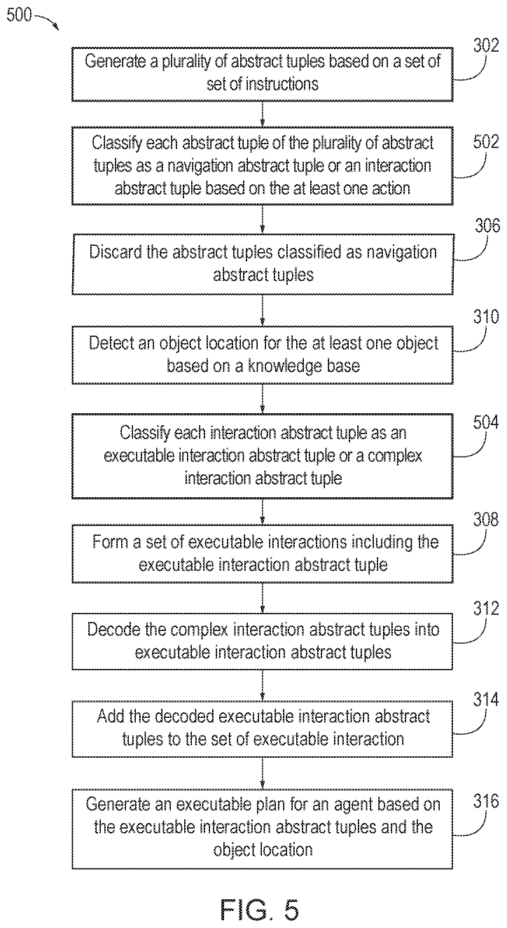

Referring now to FIG. 5, a method 500 for generalizable instruction following will now be described according to an exemplary embodiment. FIG. 5 will also be described with reference to FIGS. 1-4 and 6. For simplicity, the method 500 will be described as a sequence of elements, but it is understood that the elements of the method 500 may be organized into different architectures, blocks, stages, and/or processes. Some of the block of method 500 correspond to blocks of the method 300 and are given reference number accordingly and operate in a similar manner as described above with respect the method 300.

At block 302, the method 500 includes the tuple module 124 generating a plurality of abstract tuples based on a set of set of instructions. An abstract tuple of the plurality of abstract tuples includes at least one action and at least one object.

At block 502, the method 500 includes the classification module 126 classifying each abstract tuple of the plurality of abstract tuples as a navigation abstract tuple or an interaction abstract tuple based on the at least one action. In this manner, the abstract tuples are separated into a number of instruction categories. The instruction categories may include a first category for navigation abstract tuple and a second category for interaction tuples which includes both executable interaction abstract tuples and complex interaction abstract tuples. For example, abstract tuples including a path verb are sorted in the first category for navigation abstract tuples. Interaction abstract tuples having one or more executable actions are sorted into the second category for interaction tuples.

At block 310, the method 300 includes the interaction module 128 detecting an object location for the an object of the one or more objects 404 based on a large language model. In one embodiment, the interaction module 128 may use the semantic map 408 and common-sense candidates from large language models. For example, a BERT may be used to propose semantically meaningful candidates for masked tokens. The masked tokens represent identified objects in the semantic map 408 based on a depth prediction model 410 generated from image data 110, depth data 112, and/or tactile data 114 captured by the agent 200. The semantic map 408 may be based on the depth prediction model 410 model and the grounded language-image model 414. The interaction module 128 may use the first bounding box 416 and the second bounding box 418 to translate natural language phrases into candidate locations.

At block 504, the method 500 includes the classification module 126 classifying each interaction abstract tuple as an executable interaction abstract tuple or a complex interaction abstract tuple. The interaction tuples that are single executable interaction abstract tuples and do not require further decoding are classified as executable interaction abstract tuples. The interaction abstract tuples that do require further decoding are classified as complex interaction abstract tuples.

At block 308, the method 500 includes the interaction module 128 forming a set of executable interactions 412 including the one or more executable interaction abstract tuple. In some embodiments, the interaction module 128 may order the executable interaction abstract tuples in a sequential order in the set of executable interactions 412.

At block 312, the method 500 includes the interaction module 128 decoding the interaction abstract tuples that include multiple executable interactions, referred to as the complex interaction abstract tuples. The complex interaction abstract tuples are decoded into simple executable interactions as executable interaction abstract tuples that may be executed by an agent 200.

At block 314, the method 500 includes the interaction module 128 adding the decoded executable interaction abstract tuples to the set of executable interactions 412. The single executable interaction abstract tuples and the decoded executable interaction abstract tuples may be added to the set of executable interactions 412 to be in the sequential order of execution.

At block 316, the method 500 includes the interaction module 128 generating an executable plan 422 for an agent 200 based on the set of executable interactions 412 and the object location. For example, the execution module 130 may cause the agent 200 to execute the executable plan 422.

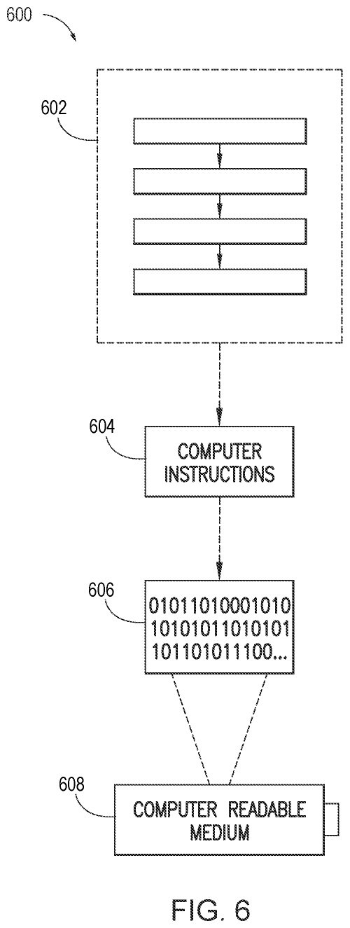

Still another aspect involves a computer-readable medium including processor-executable instructions configured to implement one aspect of the techniques presented herein. An aspect of a computer-readable medium or a computer-readable device devised in these ways is illustrated in FIG. 6, wherein an implementation 600 includes a computer-readable medium 608, such as a CD-R, DVD-R, flash drive, a platter of a hard disk drive, etc., on which is encoded computer-readable data 606. This encoded computer-readable data 606, such as binary data including a plurality of zero's and one's as shown in 606, in turn includes a set of processor-executable computer instructions 604 configured to operate according to one or more of the principles set forth herein.

In this implementation 600, the processor-executable computer instructions 604 may be configured to perform a method 602, such as the method 300 of FIG. 3 or the method 500 of FIG. 5. In another aspect, the processor-executable computer instructions 604 may be configured to implement a system, such as the operating environment 100 of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described above. Rather, the specific features and acts described above are disclosed as example aspects. Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that several of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A system for generalizable instruction following, comprising:
a processor; and
a memory storing instructions that when executed by the processor cause the processor to:
generate a plurality of abstract tuples based on a set of instructions, wherein an abstract tuple of the plurality of abstract tuples includes at least one action and at least one object;
classify each abstract tuple of the plurality of abstract tuples as a navigation abstract tuple, an executable interaction abstract tuple, or a complex interaction abstract tuple based on the at least one action, wherein the executable interaction abstract tuple includes a single executable interaction and the complex interaction abstract tuple includes multiple executable interactions;
discard the abstract tuples classified as navigation abstract tuples;
form a set of executable interactions including the executable interaction abstract tuple;
detect an object location for the at least one object based on a knowledge base;
decode the complex interaction abstract tuples into executable interaction abstract tuples;
add the decoded executable interaction abstract tuples to the set of executable interactions; and
generate an executable plan for an agent based on the set of executable interactions and the object location.

2. The system of claim 1, wherein the instructions when executed by the processor further cause the processor to detect the object location includes generating candidate locations based on proposing semantically meaningful candidates for masked tokens.

3. The system of claim 2, wherein the masked tokens represent identified objects in a semantic map based on a depth prediction model generated from image data or depth data captured by the agent.

4. The system of claim 3, wherein the semantic map is based on the depth prediction model and grounded language-image pre-training, wherein the grounded language-image pre-training converts object bounding boxes to natural language phrases.

5. The system of claim 1, wherein the instructions when executed by the processor further cause the processor to:
receive a task from a biological entity; and
identify the set of instructions based on the task.

6. The system of claim 1, wherein the executable plan is executed by the agent based on a semantic map.

7. The system of claim 1, wherein the abstract tuples are based on semantic parsing.

8. A method for generalizable instruction following, comprising:
generating a plurality of abstract tuples based on a set of instructions, wherein an abstract tuple of the plurality of abstract tuples includes at least one action and at least one object;
classifying each abstract tuple of the plurality of abstract tuples as a navigation abstract tuple, an executable interaction abstract tuple, or a complex interaction abstract tuple based on the at least one action, wherein the executable interaction abstract tuple includes a single executable interaction and the complex interaction abstract tuple includes multiple executable interactions;
discarding the abstract tuples classified as navigation abstract tuples;
forming a set of executable interactions including the executable interaction abstract tuple;
detecting an object location for the at least one object based on a knowledge base;
decoding the complex interaction abstract tuples into executable interaction abstract tuples;
adding the decoded executable interaction abstract tuples to the set of executable interactions; and
generating an executable plan for an agent based on the set of executable interactions and the object location.

9. The method of claim 8, wherein detecting the object location includes generating candidate locations based on proposing semantically meaningful candidates for masked tokens.

10. The method of claim 9, wherein the masked tokens represent identified objects in a semantic map based on a depth prediction model generated from image data or depth data captured by the agent.

11. The method of claim 10, wherein the semantic map is based on the depth prediction model and grounded language-image pre-training, wherein the grounded language-image pre-training converts object bounding boxes to natural language phrases.

12. The method of claim 8, further comprising:
receiving a task from a biological entity; and
identifying the set of instructions based on the task.

13. The method of claim 8, wherein the executable plan is executed by the agent based on a semantic map.

14. The method of claim 8, wherein the abstract tuples are based on semantic parsing.

15. A non-transitory computer readable storage medium storing instructions that when executed by a computer, which includes a processor perform a method, the method comprising:
generating a plurality of abstract tuples based on a set of set of instructions, wherein an abstract tuple of the plurality of abstract tuples includes at least one action and at least one object;
classifying each abstract tuple of the plurality of abstract tuples as a navigation abstract tuple or an interaction abstract tuple based on the at least one action;
discarding the abstract tuples classified as navigation abstract tuples;
detecting an object location for the at least one object based on a knowledge base;
classifying each interaction abstract tuple as an executable interaction abstract tuple or a complex interaction abstract tuple, wherein the executable interaction abstract tuple includes a single executable interaction and the complex interaction abstract tuple includes multiple executable interactions;
forming a set of executable interactions including the executable interaction abstract tuple;
decoding the complex interaction abstract tuples into executable interaction abstract tuples;
adding the decoded executable interaction abstract tuples to the set of executable interactions; and
generating an executable plan for an agent based on the set of executable interactions and the object location.

16. The non-transitory computer readable storage medium of claim 15, wherein detecting the object location includes generating candidate locations based on proposing semantically meaningful candidates for masked tokens.

17. The non-transitory computer readable storage medium of claim 16, wherein the masked tokens represent identified objects in a semantic map based on a depth prediction model generated from image data or depth data captured by the agent.

18. The non-transitory computer readable storage medium of claim 17, wherein the semantic map is based on the depth prediction model and grounded language-image pre-training, wherein the grounded language-image pre-training converts object bounding boxes to natural language phrases.

19. The non-transitory computer readable storage medium of claim 15, further comprising:
receiving a task from a biological entity; and
identifying the set of instructions based on the task.

20. The non-transitory computer readable storage medium of claim 15, wherein the executable plan is executed by the agent based on a semantic map.
